(19) United States
(12) Patent Application Publication
(10) Pub. No.: US 2005/0116599 A1
(43) Pub. Date: Jun. 2, 2005

(54) Storage battery on the basis of a high frequency plasma

(76) Inventor: Dietmar Dreyer, Stuttgart (DE)

Correspondence Address: Donna Lane Cadell, P. O. Box 531, Seabrook, NH, 03874, US

(21) Appl. No.: 10/766,271

(22) Filed: Jan. 29, 2004

(30) Foreign Application Priority Data
Nov. 27, 2003 (DE) 103 22 367.3

(51) Int. Cl. H01J 17/26

(52) U.S. Cl. 313/231.31

(57) ABSTRACT

In a H011-Cavity Resonator set up from reduced components, a high-frequency-reflection machine (é-pinch) constructed from Waveguide sections, short circuit at both sides, which is created for the maintaining of an internal magnetic field for the enclosure of a high temperature plasma, electric energy will be available via direct transformation of the internal thermal energy for portable consumers.

### TECHNICAL FIELD

The invention affects a high frequency—Storage Battery as nominated in the generic term of claim 1.

### BACKGROUND ART

Such high frequency-Storage batteries, which are set up under the application of a low temperature plasma, can be used principally for portable electric equipment.

Those types of known high frequency—Storage batteries had been set up since now jointly with a closed rectangle-Circular hollow space conductor for directly electric energy transformation as high frequency-resonator device in an oscillator circuit. In support of the construction for those conventional high frequency-Storage Batteries a relatively high constructive expense was necessary up to now.

The DE-BP 44 41 422 shows a high frequency-Storage Battery, with different assembly groups, like a Circular hollow space construction as of at least 8 Waveguide-components, including HF-coupling, just as different HF-equipment as coils, HF-switches and further active amplifier components. This high developing expenditure will be economically restricting against a mass production.

Furthermore in the DE-BP 44 41 422 hydrogen was used exclusively as an energy carrier. Because of this procedure it was impossible to create the unit in a compact way. Additionally a special gas was necessary for the construction.

From the DE-GM 296 12 533.4 a knob battery cell is acknowledged, which consists of a gas filled Ring-Hollow Space conductor, a HF-supply, Waveguide sections for the in-/out coupling of energy, loading capacitors and a rectifier diode as well as miscellaneous casing parts. This construction arrangement is set up likewise on the basis of a Circular hollow space conductor. Although this kind of circuit comes already without external control devices, there is likewise a high constructive expense necessary for the manufacturing of the Circular Waveguide.

### DISCLOSURE OF THE INVENTION

The construction, in contrast to the traditional assembly, is set up in form a metallic H011-Cavity Resonator, which is built in that way to increase the energy content, that a repetitively interfered transversal-electromagnetic wave is applied to permit the high temperature gas plasma spherically freely hovering, including the Waveguide conclusions (2, 3) in a distance from the casing walls.

As a carrier for direct transformation of molecular into electric energy gas like industrially available helium or neon, will be procured. The theoretical principle to this is well known and described already in various technical dissertations. Hereof again the DE-GM 296 12 533.4 in form of a knob battery cell, just as the DE-BP 44 41 422 ‘Microwave generator’ shall be mentioned.

The functionalism of this new energy transformation principle occurs in each case on the fact, that in a Cavity Resonator, constructed as a battery case, a certain gas quantity under high pressure is enclosed. Under radiation of microwave energy an ionization process occurs and free electric charges will become available. At this plasma, which presents simultaneously an enclosed electromagnetic wave with a density of very high energy, it is possible to dispose electric energy via a HF-coupling process. At a complete ionization of the carrier gas the following energy content would be theoretically available in the H011-Cavity Resonator:

$$\begin{matrix}{W}_{i} = {\int }_{O}^{I} L \cdot I ⅆ I \\ = L \cdot \frac{{I}^{2} \cdot sin ( ω \cdot t )}{2} \\ = \frac{1}{2} \cdot L \cdot {I}^{2} \\ = {m}_{P1} \cdot {c}_{p} \cdot ( T - {T}_{a} ) [ Ws ] \\ I ( T ) := \sqrt{\frac{2}{L} \cdot [ {m}_{P1} \cdot {c}_{p} \cdot ( T - {T}_{a} ) ]}\end{matrix} \qquad ( Gl . 1 )$$

### BRIEF DESCRIPTION OF THE DRAWINGS

The invention bases on the task, to avoid the projected disadvantages and to create such an extent compact device subsequent to the already specified principles with reduced component costs, which eliminates these problems.

FIG. 4 presents a block circuit diagram of the Storage Battery. The device consists thereby of the following main components. These are to be described with one on both sides short-circuited Waveguide sections (1), Waveguide endings (2, 3), a HF-connection (4), plugs (5, 6) for power distribution, HF-supply conductors (7), a Schottky-diode (8) including Load capacitor (9) for rectification of the HF-energy as well as a casing box (11) with isolation material (10). Because of the used HF components the complete circuit is constructed in Micro strip technology. For battery charging during the production process and for recharging a separate HF-charge device like e. g. a Magnetron is necessary.

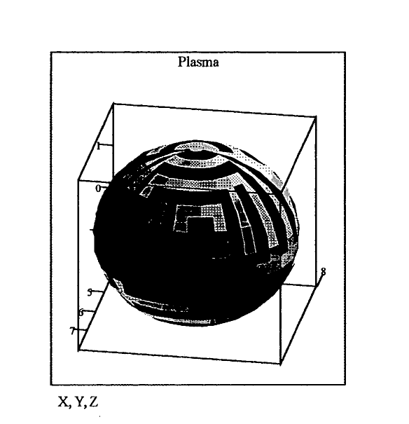

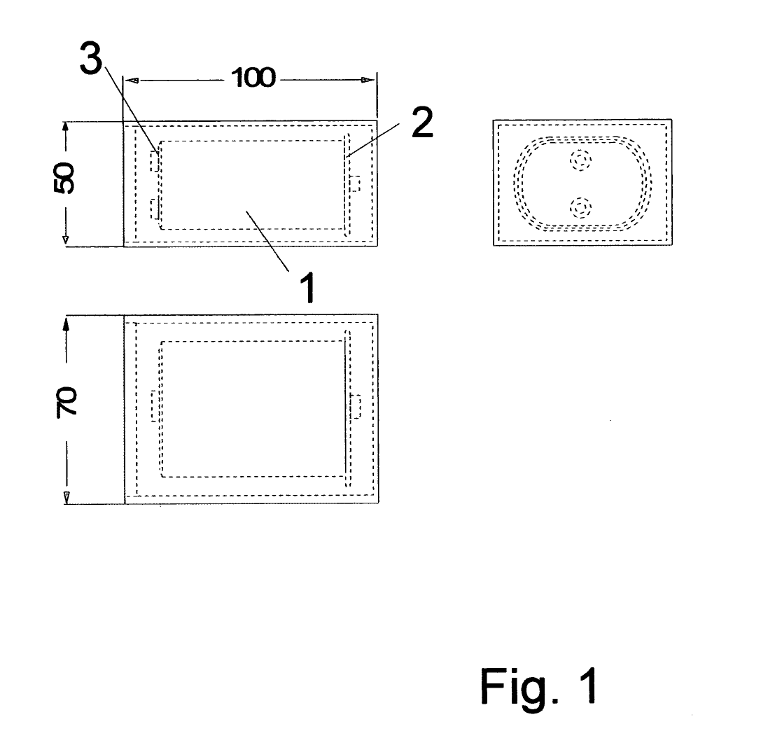

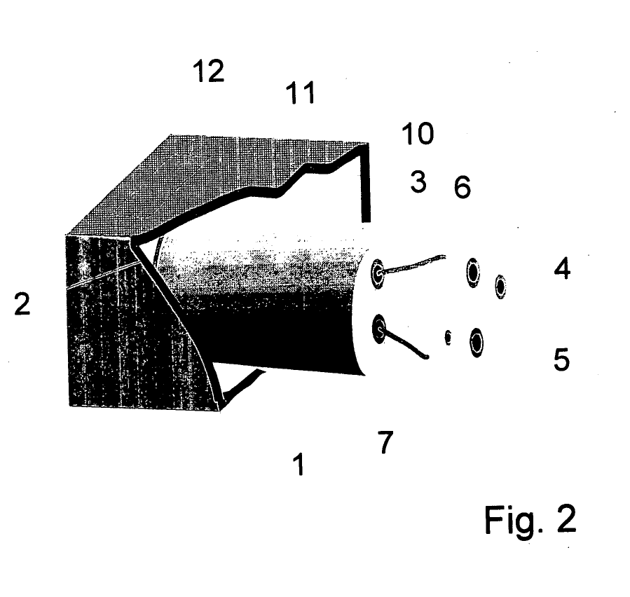

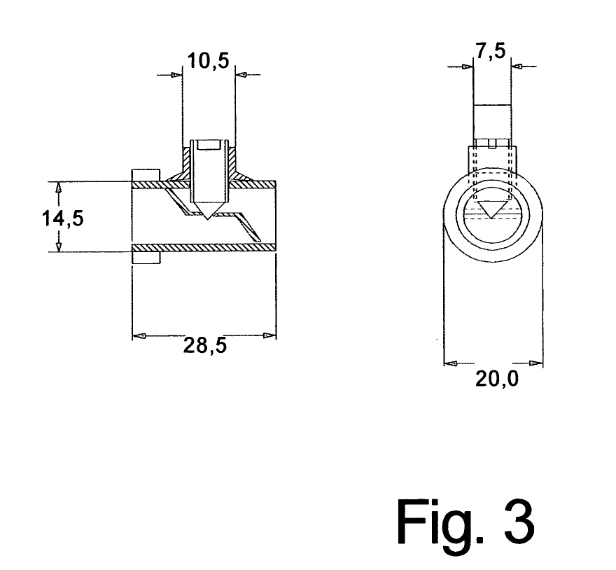

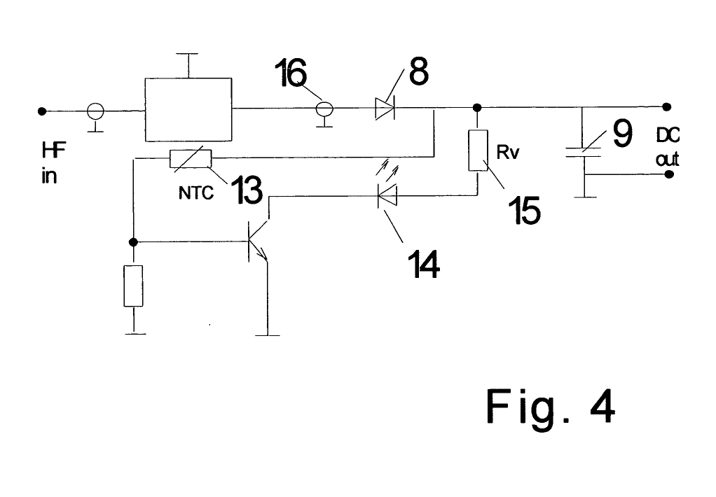

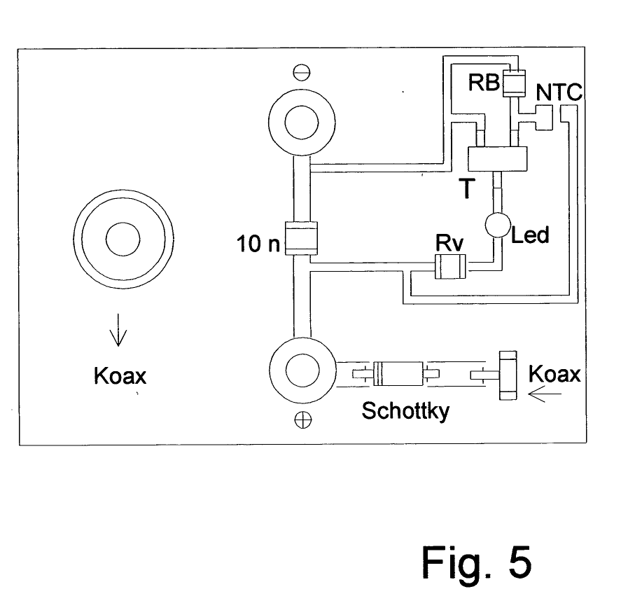

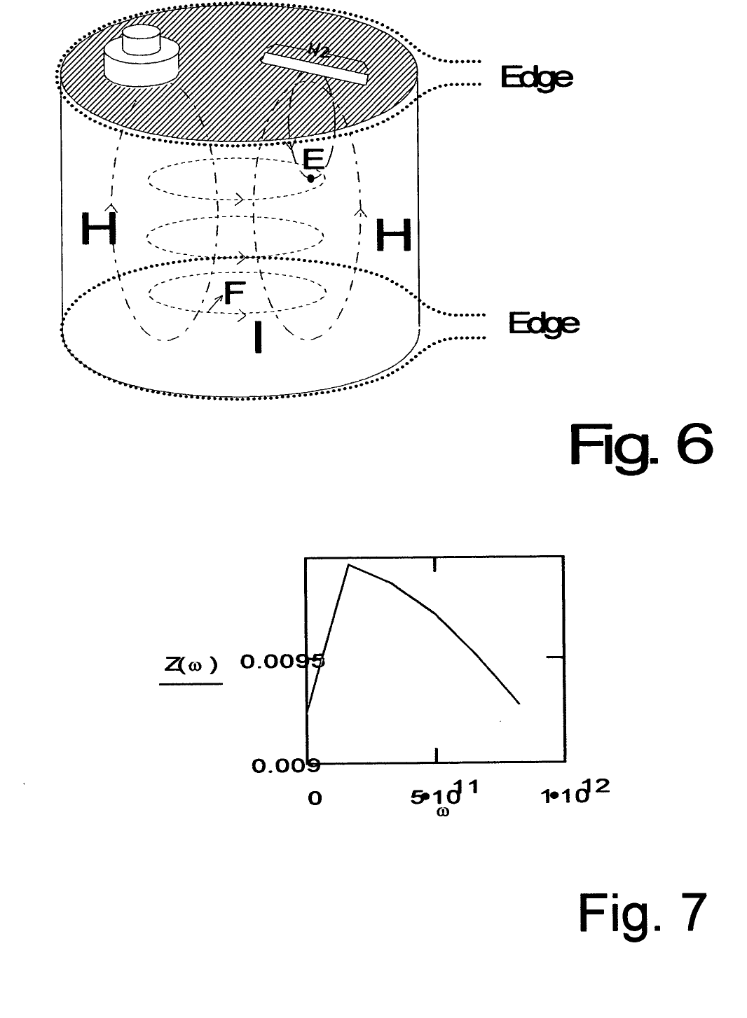

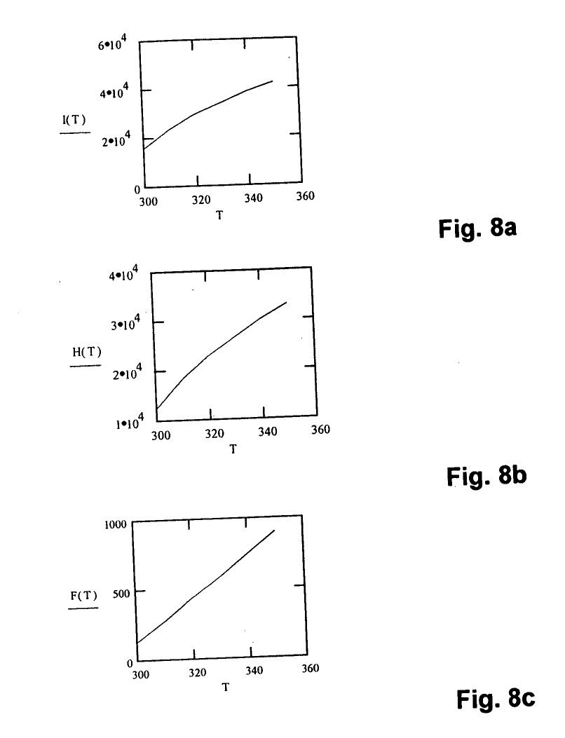

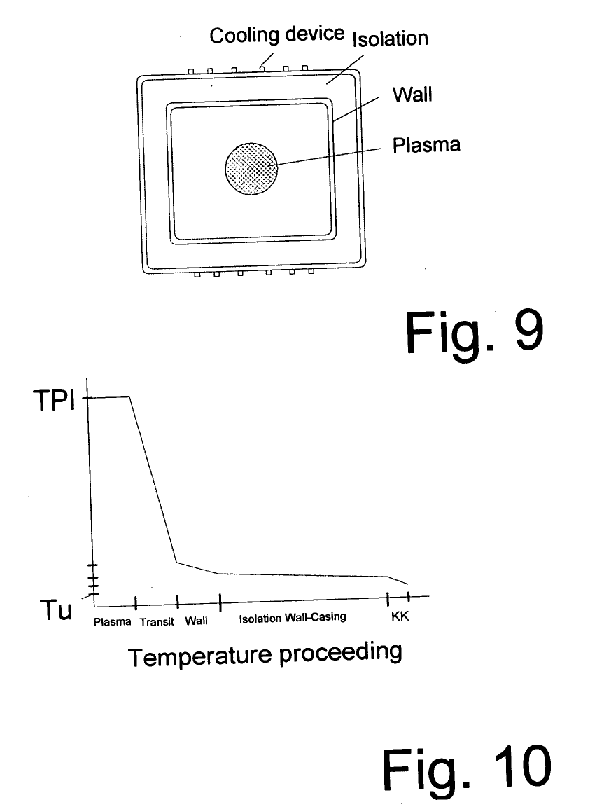

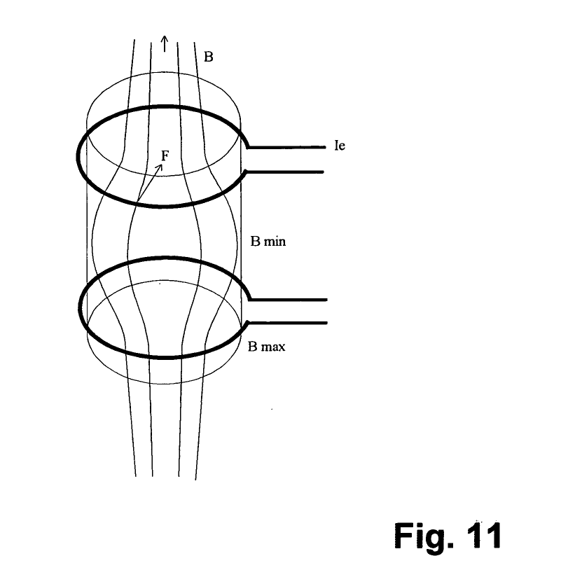

### BEST MODES FOR CARRYING OUT THE INVENTION

During the battery production process the H011-Cavity Resonator (1-3) will be filled with a defined quantity of gas, e.g. neon or helium, via the gas refill valve, as shown in FIG. 3. The plasma pot is thereby, in contrast to the traditional technology, constructed as a magnetic bottle. Differently this construction can be described itself also as high frequency-reflection machine (é-pinch after FIG. 11) that is responsible for the maintaining of the necessary magnetic field for the inclusion of the high temperature plasma.

On physical view thereby, as seen in FIG. 6, the inner formed transversal electromagnetic wave like a high temperature gas plasma inside of the H011-Cavity Resonator (1-3), including the Waveguide conclusions (2, 3), will hover spherically freely from the casing walls, as shown in FIG. 9 and FIG. 10.

After the final assembly of the Storage Battery, HF-energy will be emitted into the Cavity Resonator as well via the HF-supply conductors (4) as via the Waveguide ending with HF-supply (3).

To ensure, that the Cavity Resonator for the resonance frequency is created in the correct mathematical way the following parameters have to be checked:

$$Z ( ω ) := \frac{1}{\sqrt{\frac{1}{{R}^{2}} + {( ω \cdot C - \frac{1}{ω \cdot L} )}^{2}}} \qquad ( Gl . 2 )$$

FIG. 7 portrates hereby the reactive resistance Z in dependency on the frequency f

Via the emitted microwave energy the electrons will be released now from the atom trunks while forming ionized plasma. Causing of the energy balance inside the cavity resonator electric charges set up an electrical field of high density and generate a loop current as described in equation (1).

These electric currents produce therefore with it in addition a magnetic field, which can be described after equation (3).

$$H ( T ) := \sqrt{\frac{2 \cdot [ {m}_{P1} \cdot {c}_{p} \cdot ( T - {T}_{a} ) ]}{{μ}_{0} \cdot {μ}_{r} \cdot a \cdot b \cdot 1}} \qquad ( Gl . 3 )$$

This generated magnetic field obtains again a force F, which includes the ionisizeed gas internal of the H011-Cavity Resonator and protects it from damages through high pressure, like shown in FIG. 9 and FIG. 10.
F=I(T)*1* H(T) (Gl. 4)

The parameters 1 presents herewith the field length within the H011-Cavity Resonator. The related functions of the equations 1-5 are corresponding to FIG. 7-8.

Once more it is to be mentioned, that the maintaining of the battery function will be realized without any external oscillator circuit support and only by the Cavity Resonator body (1-3) and its dimensions.

For the decrease the thermal radiation of the included ionized gas an additional isolation (10) is constructed around the Cavity Resonator body (1-3).

The isolation helps likewise, to increase the thermal efficiency in relation to the provided energy.

After the present state of technology it makes no difficulties, to manufacture the treated electric battery in mass production, because all components are available on the market.

1. Storage Battery on the basis of a high frequency plasma, consisting of a H011-Cavity Resonator (1) with Waveguide endings (2, 3), an Induction coupling (4), plugs (5, 6) for energy distribution, HF-Supply conductings (7), a Schottky-diode (8) including Load capacitor (9) for the rectification of the out-coupled HF-energy as well as a casing (11) for the prevention of HF-Emission including isolation material (10) for decreasing of thermal losses, thereby noticed, that the complete construction works like the principle of compression via ionisated gases in a high frequency, axial magnetic field (high frequency-reflection machine, é-pinch, FIG. 11) and therefore leads to the inclusion of the plasma under additional exploitation of the increased magnetic field at the ends of the cavity resonator emerging a reflection of the loaded particles for a creation of essential Enclosing forces.

2. Storage Battery on the basis of a high frequency plasma of claim 1, thereby noticed, that in both short circuit Waveguide stages (1), constructed as a H011-Cavity Resonator, the resonance frequency of the high temperature plasma beyond the critical frequency is procured for energy charging.

3. Storage Battery on the basis of a high frequency plasma of claim 1 and 2, thereby noticed, that after the creation of the plasma flow the eddy currents themselves, caused by the magnetic field B in the cavity resonator, will be used for energy storage.

4. Storage Battery on the basis of a high frequency plasma after claim 1 to 3, thereby noticed, that the internal shaped transversal electromagnetic wave form itself will be used in that way, that the high frequency plasma will be hold in those sections of the HO011-Cavity Resonator (1-3) including the Waveguide endings (2, 3) while hovering freely spherically from the casing walls.

5. Storage Battery on the basis of a high frequency plasma after claim 1 to 4, thereby noticed, that the maintaining of the battery function will be realized only by the resonance frequency of the Cavity Resonator—body (1-3) and without any support by an external oscillator circuit.

6. Storage Battery on the basis of a high frequency plasma after claim 1 to 5, thereby noticed, that for the plasma heating of the medium of the energy carrier neon or helium will be obtained.

7. Storage Battery on the basis of a high frequency plasma after claim 1 to 6, thereby noticed, that for thermal Emission decrease of the included ionized gas an isolation (10) of the Cavity Resonator—body (1-3) in a separate casing (11) will be used.
